(19) United States
(12) Patent Application Publication
(10) Pub. No.: US 2008/0201434 A1
(43) Pub. Date: Aug. 21, 2008

(54) Context-Sensitive Searches and Functionality for Instant Messaging Applications

(75) Inventors: John S. Holmes, Seattle, WA (US); Heather Ferguson, Centralia, WA (US); Adam C. Czeisler, Seattle, WA (US); Joshua T. Goodman, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/675,787

(22) Filed: Feb. 16, 2007

(51) Int. Cl. G06F 15/16

(52) U.S. Cl. 709/206

(57) ABSTRACT

In one or more embodiments, in the context of an instant messaging application, a conversation is analyzed and contextually or textually relevant keywords and/or phrases are identified. These keywords or phrases are then highlighted in a visually-identifiable manner for selection by an individual participating in the conversation. Once selected by an individual, a user interface is presented and exposes the individual or individuals in the conversation to various contextually- or textually-relevant material or functionality that pertains to the selected word or phrase. In one or more embodiments, an individual can also manually select a word or phrase to access the user interface that exposes contextually or textually-relevant material or functionality. In the various embodiments described below, at least some of this relevant material or functionality is presented to the user in the context of the instant messaging application and in a manner in which it can be consumed by the individual within the instant messaging application itself.

### BACKGROUND

In general, individuals who have instant messaging conversations will often find that they have to transition out of, or tab out of the context of their instant messaging application in order to access some other type of information or functionality that is, or may be germane to the topic of their conversation For example, two individuals may be instant messaging with each other and may be discussing their dinner plans for the evening. Undecided on a restaurant, one of the individuals may pause the conversation, launch an internet search engine outside of the context of the instant messaging application, perform an appropriate search to see a list of restaurants that match their search terms, and decide upon one or two restaurant possibilities. The individual may then select and copy a couple of the restaurant possibilities, re-enter their instant messaging conversation context, paste the copied results into an associated conversation window and send the results to the other individual for evaluation.

This type of user experience, as well as others, leaves much to be desired insofar as the burden it places on the individual to seek out and acquire information that is supplemental to, or otherwise useful in the context of the conversation that they are currently having.

### SUMMARY

In one or more embodiments, in the context of an instant messaging application, a conversation is analyzed and contextually or textually relevant keywords and/or phrases are identified. These keywords or phrases are then highlighted in a visually-identifiable manner for selection by an individual participating in the conversation. Once selected by an individual, a user interface is presented and exposes the individual or individuals in the conversation to various contextually- or textually-relevant material or functionality that pertains to the selected word or phrase. In one or more embodiments, an individual can also manually select a word or phrase to access the user interface that exposes contextually or textually-relevant material or functionality. In the various embodiments described below, at least some of this relevant material or functionality is presented to the user in the context of the instant messaging application and in a manner in which it can be consumed by the individual within the instant messaging application itself

### BRIEF DESCRIPTION OF THE DRAWINGS

FIG. 1 illustrates a system that includes a presence-based network in accordance with one embodiment.

FIG. 2 illustrates an exemplary application in the form of an instant messaging application that exposes a conversation window in accordance with one embodiment.

FIG. 3 illustrates an exemplary conversation window in an instant messaging application in accordance with one embodiment.

FIG. 4 illustrates an exemplary conversation window in an instant messaging application having an exemplary user interface in accordance with one embodiment.

FIG. 5 illustrates an exemplary user interface in accordance with one embodiment.

FIG. 6 is a flow diagram that describes steps in a method in accordance with one embodiment.

FIG. 7 illustrates the FIG. 3 conversation window with a user interface in accordance with one embodiment.

FIG. 8 is a flow diagram that describes steps in a method in accordance with one embodiment.

FIG. 9 illustrates an exemplary architecture in accordance with one embodiment.

### DETAILED DESCRIPTION

Overview

In one or more embodiments, in the context of an instant messaging application, a conversation is analyzed and contextually or textually relevant keywords and/or phrases are identified. These keywords or phrases are then highlighted in a visually-identifiable manner for selection by an individual participating in the conversation. Once selected by an individual, a user interface is presented and exposes the individual or individuals in the conversation to various contextually- or textually-relevant material or functionality that pertains to the selected word or phrase. In one or more embodiments, an individual can also manually select a word or phrase to access the user interface that exposes contextually or textually-relevant material or functionality. In the various embodiments described below, at least some of this relevant material or functionality is presented to the user in the context of the instant messaging application and in a manner in which it can be consumed by the individual within the instant messaging application itself.

Instant messaging applications are typically employed in connection with a presence-based network. In the discussion that follows, in successive sections entitled “Presence In General” and “Exemplary Presence-Based Network”, the notion of a presence-based network is described to provide the reader who is unfamiliar with such networks and associated presence-based applications some context for appreciating the described embodiments. Following this, a discussion of various inventive embodiments is provided in the context of a presence-based network.

Presence In General

The notion of presence typically implies the use of a server or service that runs and keeps online users updated with each other's contacts' online status. That is, in a presence-based network, users can identify so-called contacts the same or similar to those that appear in the user's email address list. Whenever a contact is online, the presence-based network notifies the user so that the user can leverage the services provided by the network—such as instant messaging, peer-to-peer file exchange and the like. That is, the presence-based network can enable contacts that are online together to communicate in a real-time fashion.

One commercially-available software product that provides presence capabilities is Microsoft's Windows® Live Messenger, although other products are available and can certainly be used in connection with the concepts described in this document. Microsoft's Windows® Live Messenger is a rich, integrated real-time communications experience that enables people to effortlessly see, talk, work and play with friends, family and colleagues, whenever and however they choose using their personal computer. Windows® Live Messenger also includes presence and notification features to keep users updated when their contacts are online and let users know their current status.

Various embodiments described below can leverage the functionality provided by a presence-based network. It is to be appreciated and understood that Microsoft's Windows® Live Messenger constitutes but one exemplary application that can be utilized in this context. As such, other applications can be utilized without departing from the spirit and scope of the claimed subject matter.

Exemplary Presence-Based Network

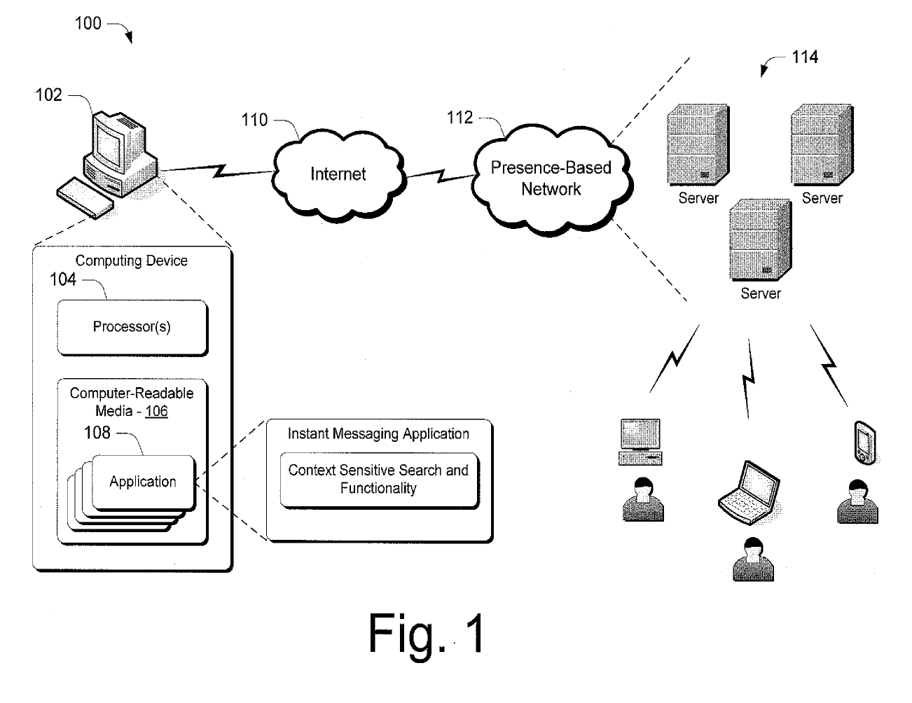

As an example of a presence-based network in accordance with one embodiment, consider FIG. 1 which illustrates such a network or system generally at 100. System 100 includes one or more computing devices 102 each of which includes one or more processors 104, one or more computer-readable media 106 and one or more applications 108 that reside on the computer-readable media and which are executable by the processor(s). In at least one embodiment, one of the applications resides in the form of an instant messaging application that includes context sensitive search and functionality such as that described below.

Although computing device 102 is illustrated in the form of a desktop computer, it is to be appreciated and understood that other computing devices can be utilized without departing from the spirit and scope of the claimed subject matter. For example, other computing devices can include, by way of example and not limitation, portable computers, handheld computers such as personal digital assistants (PDAs), cell phones and the like.

System 100 also includes a network, such as the Internet 110 that is used by computing device 102 to communicate with a presence-based network 112. Any suitable protocols can be utilized to enable communication between computing device 102 and presence-based network 112.

As shown, presence-based network 112 includes one or more servers 114 that implement the presence environment, as will be appreciated by the skilled artisan. The presence-based network can be one that includes or supports the use of instant messaging, VoIP, voice clips and the like—all of which can permit a user of computing device 102 to communicate with the network and other users of the network. Instant messaging, VoIP and voice clip protocols will be understood by the skilled artisan and, for the sake of brevity, are not further described here. It is to be appreciated and understood that the embodiments described herein can be utilized in connection with these and other protocols. Specifically, the various embodiments can be utilized in connection with textual conversations, as well as VoIP conversations and the like, as will become apparent below.

The presence-based network includes other human users that can communicate with the user of computing device 102 using any of a variety of computing devices as indicated. In practice, when a user in a presence-based network enters into a conversation with another, some type of a user interface is presented to the user through which the conversation can take place.

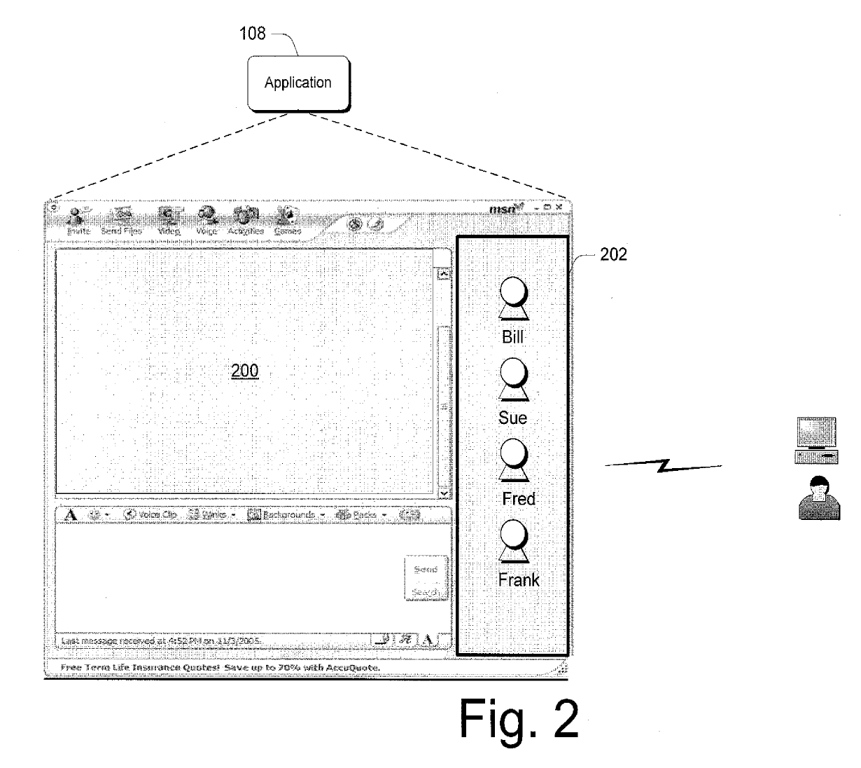

As but one example, consider FIG. 2 which illustrates, from FIG. 1, an application 108 in the form of an instant messaging application and one human user with which a user of the instant messaging application is conversing. Here, instant messaging application 108 presents, on a user's computing device, a user interface that includes a so-called conversation window 200 which permits the user to have conversations with various contacts or others who are online. In addition, application 108 provides a contact list 202 that lists the various contacts of a user who happen to be on line at the present time. Thus, in this example, Bill, Sue, Fred and Frank are currently on line and the user may choose to initiate a conversation with any or all of them.

Having now discussed the notion of a presence-based network, the discussion now turns to various inventive embodiments In the sections that follow, a section entitled “Identifying Keywords and Phrases” is provided and discusses various ways in which keywords and phrases can be identified and various manners in which a user can be presented with a user interface that enables the user to interact with contextually-relevant information and/or functionality. Following this, a section entitled “Sources of Keywords and/or Phrases” is provided and describes, by way of example and not limitation, a number of different sources of keywords that can be utilized to analyze an instant messaging conversation. Finally, a section entitled “Exemplary Architecture” is provided and describes, at a high level, various aspects of an architecture that can be employed to implement the above-described functionality in accordance with one or more embodiments.

Identifying Keywords and Phrases

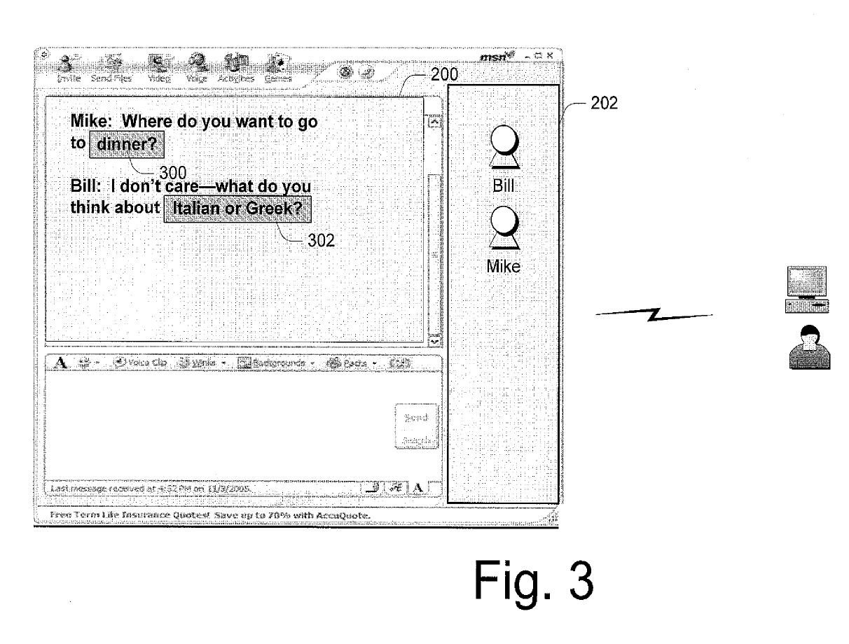

FIG. 3 illustrates an exemplary conversation window in an instant messaging application in accordance with one embodiment. Here, a conversation is taking place between Mike and Bill and pertains to where the two individuals are going to eat dinner. Here, Mike has asked Bill where he wants to go for dinner, to which Bill responds that he does not care. In the context of this conversation though, Bill asks Mike what he thinks about Italian or Greek for cuisine possibilities. Notice in this example that the instant messaging application has automatically highlighted some textually relevant keywords of interest-that is, “dinner” at 300, and “Italian or Greek” at 302. Highlighting can take place in any suitable way. By way of example and not limitation, keywords and phrases can be underscored, a selectable icon can appear next to them or, as in the present example, can be visually highlighted as by being enclosed in a visually distinctive box. Further, keywords can be identified in any suitable way using any suitable techniques, sources and/or algorithms, examples of which are provided below.

Once the keywords and phrases have been identified and highlighted, a user can select a particular keyword or phrase and have a user interface displayed that exposes the user or users in the conversation to various textually-relevant material or functionality that pertains to the selected keyword or phrase. It is to be appreciated and understood that the individuals themselves can manually select a keyword or phrase to be exposed to the functionality described just below.

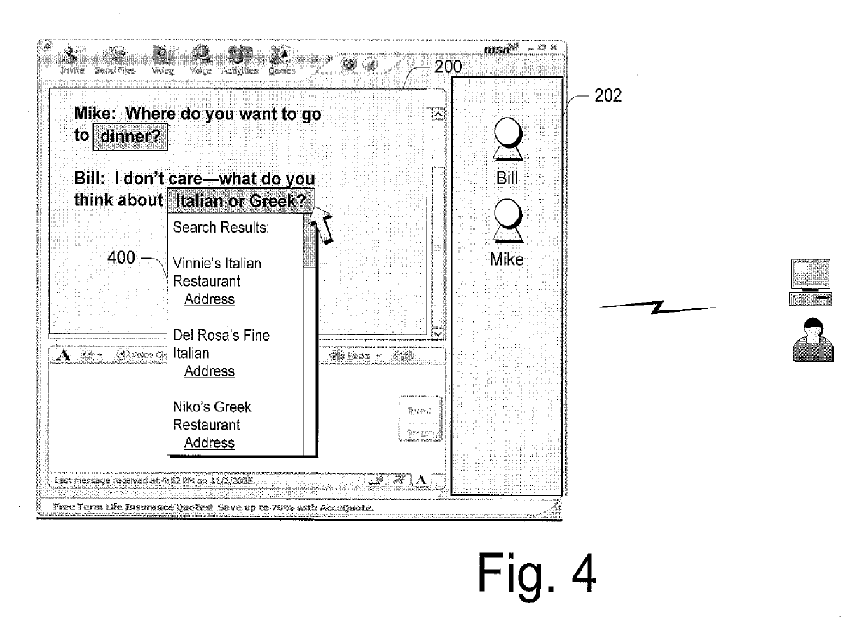

As an example, consider FIG. 4. There, the FIG. 3 conversation window is illustrated along with an exemplary user interface 400. Notice here that the user has used their cursor to hover over or otherwise select the highlighted “Italian or Greek” selection. Responsively, a user interface in the form of a dropdown menu is presented and automatically displays search results that are germane to the context of the user's conversation. Specifically, in this example, since the users are talking about Italian or Greek restaurants as dining possibilities, a number of search results are displayed that pertain to Italian or Greek restaurants that are near the users. In this example, the search results include a link that the users can click on to get a restaurant's address and, in at least some embodiments, a map from their current location. In one or more embodiments, the dropdown menu is scrollable so that the users can scroll down to see all of the information that is presented in the user interface. In one or more embodiments, when keywords or phrases are highlighted on a first user's interface, the same keywords or phrases are highlighted in the respective user interfaces of the other users with which the first user is conversing. In addition, in these embodiments, the same search results can be displayed for the other conversation participants as well. It is to be appreciated and understood that in these and other embodiments, that information that is specific to the various users is utilized to tailor search results uniquely for them. In addition, it at least some embodiments, this can be automatically performed.

In practice, when the information that is displayed in the user interface pertains to search results, the instant messaging application can utilize an internet search engine, such as live.com, to very quickly perform a search of the selected terms so that the results can be displayed for the user. Thus, in at least some embodiments, a search can be performed in the background so that the results can be presented to the user or users.

In the above example, the user interface is utilized to present search results to the user. However, other useful and contextually relevant information can be presented for the user.

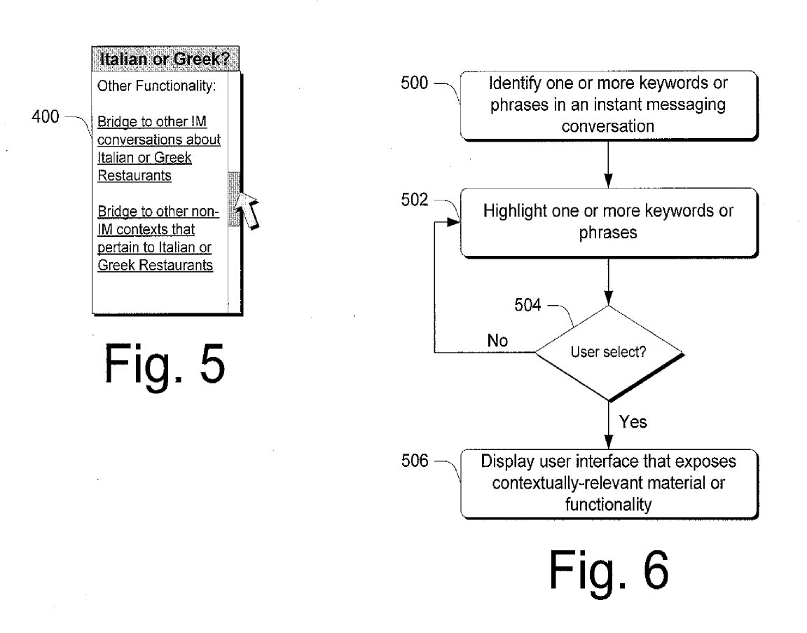

As an example, consider FIG. 5 which illustrates FIG. 3's user interface 400 in which the user has scrolled down to be exposed to other functionality that can be offered through the user interface. In this example, the functionality can pertain to other instant messaging functionality or non-instant messaging functionality.

Specifically, in this example, the user can select an option that allows them to participate in other instant messaging conversations about Italian or Greek restaurants. Accordingly, here, the user can join other groups for relevant discussion on the topic of interest. Alternately or additionally, the user can select an option that allows them to participate in non-instant messaging based contexts that pertain to Italian or Greek restaurants. Such other context can include any suitable contexts such as, by way of example and not limitation, blogs that pertain to the topic at hand, various context-related web sites and the like. For example, perhaps one or more of the restaurants supports a web page that can be used to make reservations. In this case, by selecting an appropriate displayed link, the user can be navigated out of the instant messaging context and to the restaurant's web site.

In at least some embodiments, if a user elects to participate in a non-instant messaging based context, they can be given an opportunity to create a web resource for the particular topic of interest. For example, if the user elects to participate in a blog about Italian restaurants and they are the first user to elect to do so, they can be given an opportunity to create the blog for others to use.

FIG. 6 is a flow diagram that describes steps in a method in accordance with one embodiment. The method can be implemented in connection with any suitable hardware, software, firmware or combination thereof. In at least some embodiments, the method can be implemented in software in the form of an instant messaging application.

Step 500 identifies one or more keywords or phrases in an instant messaging conversation. Examples of how this can be done are provided above and below. Step 502 highlights one or more of the keywords or phrases. Highlighting can be performed in any suitable way, for example either manually or automatically. Step 504 ascertains whether a user has selected a highlighted keyword. This step can be performed in any suitable way examples of which are provided above. If a user does not select a particular keyword or phrase, the method loops back to step 502. If the user selects a highlighted word, step 506 displays a user interface that exposes contextually-relevant material or functionality to the user. Examples of contextually relevant material or functionality are provided above and below.

Shared User Interface Area

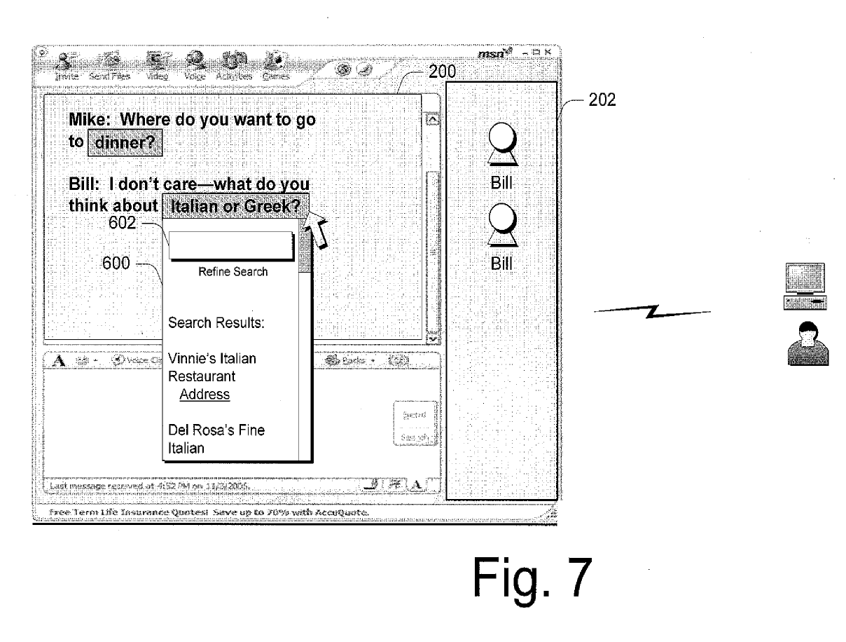

In one or more embodiments, a portion of the user interface that is presented to the users taking part in a conversation includes a shared area in which the conversation's users can jointly interact with each other and/or with the contextually relevant material and/or functionality that is presented. As an example, consider FIG. 7 which illustrates the FIG. 3 conversation window with a user interface 600 that is similar to user interface 400 of FIG. 5. Here, however, notice that user interface 600 includes a search area 602 in which a user or users Can enter search terms which can, in at least some instances, further refine the results that are displayed for them. In one or more embodiments, queries that are entered by one user are shared with other conversation participants so that the same search results can be displayed for all conversation participants.

For example, assume that Mike and Bill are having the illustrated conversation. Assume also that they are presented with the search results from above. Perhaps in this case, Mike would like to see a listing of Greek restaurants in or around the Bellevue area. In this case, Mike might enter “Greek restaurant” and “Bellevue” as search terms in the search area 602. This search query would be shared with Bill's instant messaging client and the search results for Mike's query would be displayed for each of them.

As implied in the above examples, the contextually-relevant material and/or functionality that the users are exposed to can be location-based. That is, in one or more embodiments, each individual user's instant messaging client can acquire location information either manually via user entry or automatically, as by GPS, cell node and the like. By knowing the location of the individual conversation participants, location-based, contextually relevant material can be presented. For example, in one or more embodiments, contextually-relevant functionality in the form of directions from location to location, or a visually-displayable map can be rendered for individual users in the appropriate contexts. For example, if Mike and Bill are both in Bellevue and decide on a particular restaurant, one or both of them may not know where the restaurant is located. In this instance, a link may be provided in the instant messaging client which, when clicked upon, displays an annotated map which shows how each of them should proceed from their current location to the restaurant.

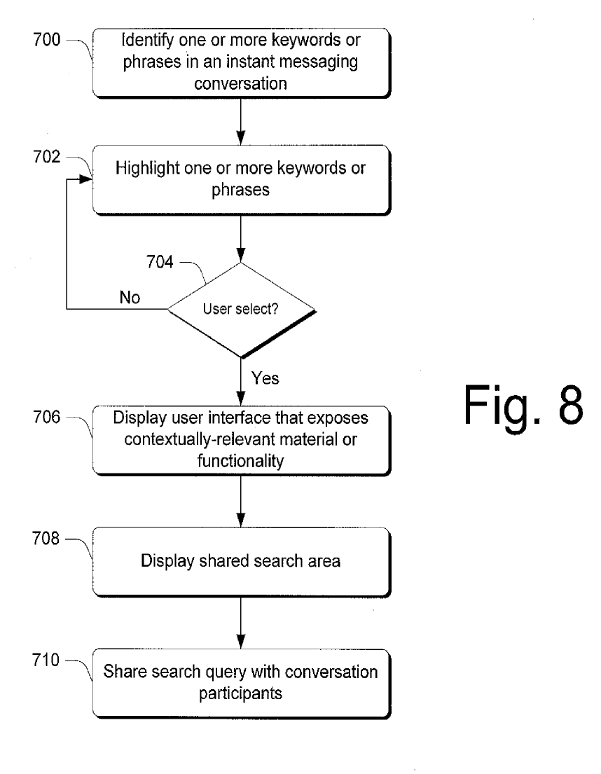

FIG. 8 is a flow diagram that describes steps in a method in accordance with one embodiment. The method can be implemented in connection with any suitable hardware, software, firmware or combination thereof In at least some embodiments, the method can be implemented in software in the form of an instant messaging application.

Step 700 identifies one or more keywords or phrases in an instant messaging conversation. Examples of how this can be done are provided above and below. Step 702 highlights one or more of the keywords or phrases. Highlighting can be performed in any suitable way, for example either manually or automatically. Step 704 ascertains whether a user has selected a highlighted keyword. This step can be performed in any suitable way examples of which are provided above If a user does not select a particular keyword or phrase, the method loops back to step 702. If the user selects a highlighted word, step 706 displays a user interface that exposes contextually-relevant material or functionality to the user. Examples of contextually relevant material or functionality are provided above and below. Step 708 displays a shared search area. The shared search area can be used to embellish search results that are currently displayed for the users. Alternately or additionally, the shared search area can be used to generate new independent searches. An example of a shared search area is provided above. Step 710 shares individual search queries with individual conversation participants. In one or more embodiments, sharing the search query permits the search's results to be uniformly displayed for all of the conversation participants.

Displaying Relevant Ads

In one or more embodiments, the contextually-relevant material and/or functionality that can be displayed for conversation participants can include various advertisements. For example, when Mike and Bill are having their restaurant discussion, relevant ads for Greek and/or Italian restaurants may be presented along the bottom or side of the user interface that is displayed for them.

Having discussed the notion of identifying keywords and phrases, as well various contextually-relevant material and functionality that can be exposed to the users, consider now various sources of keywords and phrases.

Sources of Keywords and/or Phrases

Keywords and phrases can come from many different sources. The description below is intended to illustrate exemplary sources of keywords and phrases. As such, it is not intended to be limiting in this regard. Accordingly, keywords and phrases can be sourced from any suitable location.

One source of keywords or phrases can be from the local instant messaging client itself. That is, the instant messaging client can have one or more pre-configured modules that are programmed with keywords or phrases that can be utilized to identify keywords or phrases in a conversation. Once identified in a conversation, the keywords can be used to provide the functionality described above.

Another source of keywords or phrases can be from so-called plug-in recognizers. A plug-in recognizer can be thought of as a module that is designed by a third party or another entity that includes keywords or phrases that may be specialized in some way. For example, a third party might build a plug-in recognizer that is configured to recognize medical, dental or legal terms. Alternately or additionally, a plug-in recognizer might be configured to recognize culinary or cooking terms. The functionality provided by the plug-in recognizer can be provided either locally or remotely. For example, if the knowledge base of words is rather small, the plug-in recognizer might be located locally. On the other hand, if the knowledge base of words and the associated functionality provided by the recognizer is quite large, it might be located remotely from the device on which the instant messaging client is located. In one or more embodiments, plug-ins can, in addition to recognizing keywords or phrases, provide content that can be rendered by the instant messaging client. For example, a plug-in might, in connection with identifying one or more relevant words, provides URLs for a user to access relevant information.

Another source of keywords or phrases is those keywords or phrases that individuals on a user's buddy list find interesting. Thus, if one buddy finds a number of different keywords interesting, those keywords can be added to a list of keywords for all of that individual's buddies.

Another source of keywords or phrases can be a source that keeps a dynamic list of keywords across a large group of users. In this instance, the list of keywords or phrases is dynamic and changing, thus reflecting current topics of interest across a large user base.

Having discussed a number of different sources of keywords, consider now an exemplary architecture and some components that can be utilized to implement at least some of the functionality described above.

Exemplary Architecture

In the discussion that follows, an exemplary architecture is described and constitutes one exemplary architecture that can be utilized to implement the functionality described above. It is to be appreciated and understood that the described architecture is for exemplary purposes and is not to be used to limit application of the claimed subject matter to one particular architecture. Rather, other architectures can be utilized without departing from the spirit and scope of the claimed subject matter.

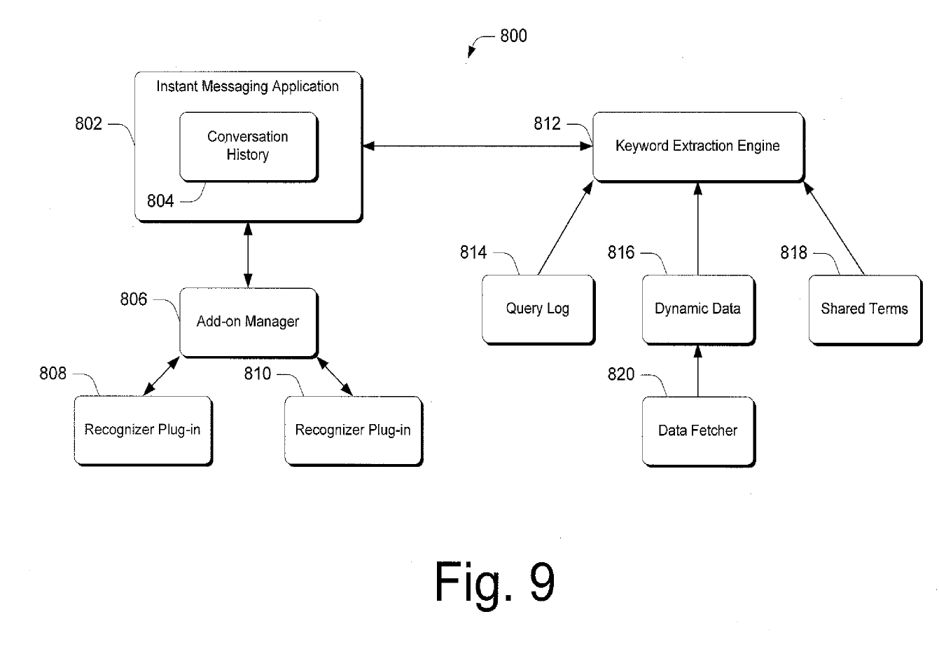

FIG. 9 illustrates an exemplary architecture in accordance with one embodiment generally at 800. Here, architecture 800 includes an instant messaging application 802 having a conversation history 804 which maintains a history of conversations that a user may have. In addition, architecture 800 includes one or more add-on managers 806 and one or more recognizer plug-ins 808, 810.

Further, a keyword extractor 812 is provided and is associated with and s receives keywords or phrases from sources that include a query log component 814, a dynamic data component 816 and/or a shared terms component 818. Dynamic data component 816 receives its keywords or phrases from any of a number of data fetchers 820.

In practice, the add-on manager 806 manages the various plug-ins that can be utilized to recognize keywords or phrases. When a user has a conversation, the conversation history is passed to the add-on manager which, in turn, passes the conversation to one or more of the plug-ins 808, 810. If particular keywords or phrases are recognized, then the words or phrases are highlighted.

The keyword extraction engine 812 is configured to be able to process a conversation and identify keywords or phrases. In this example, the keyword extraction engine can receive keywords from multiple different sources.

Specifically, the query log component 814 can keep a list of keywords or 1s phrases that have been used as queries across multiple users-and not just users in an individual's buddy list. Further, the groups of users can be broken down in terms of their demographics. So, for example, the query log might include a primary list of queries across all users, and then various sub-lists of queries across age groups, and various other demographically distinct entities.

The dynamic data component 816 can keep a list of keywords that tend to change fairly frequently. For example, current news, sports or weather items, such as those that occur globally, regionally and/or locally can be maintained by the dynamic data component and used as a source of keywords. These terms can be supplied to the dynamic data component by any of a number of specialized data fetchers, as will be appreciated by the skilled artisan.

The shared terms component 818 can keep a list of keywords or phrases that are shared amongst users in a particular individual's buddy list.

Accordingly, when an individual has a conversation with another, both the recognizer plug-ins 808, 810 and the keyword extraction engine 812 can use their respective sources of keywords to receive, process and analyze a conversation for keywords. If a particular keyword or phrase is found, then the various contextually-relevant information and/or functionality described above can be exposed to the user.

### CONCLUSION

In one or more embodiments, in the context of an instant messaging application, a conversation is analyzed and contextually or textually relevant keywords and/or phrases are identified. These keywords or phrases are then highlighted in a visually-identifiable manner for selection by an individual participating in the conversation. Once selected by an individual, a user interface is presented and exposes the individual or individuals in the conversation to various contextually- or textually-relevant material or functionality that pertains to the selected word or phrase. In one or more embodiments, an individual can also manually select a word or phrase to access the user interface that exposes contextually or textually-relevant material or functionality. In the various embodiments described below, at least some of this relevant material or functionality is presented to the user in the context of the instant messaging application and in a manner in which it can be consumed by the individual within the instant messaging application itself

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method implemented, at least in part, by a computer, the method comprising:
highlighting one or more keywords or phrases in an instant messaging conversation;
receiving a user selection of said one or more keywords or phrases; and
responsive to said receiving, presenting a user interface that exposes contextually relevant material or functionality that pertains to the selected one or more keywords or phrases.

2. The method of claim 1, wherein said highlighting comprises visually highlighting said one or more keywords or phrases.

3. The method of claim 1, wherein the act of highlighting is performed automatically by an instant messaging application.

4. The method of claim 1, wherein the act of presenting is performed in the context of an instant messaging application in which said conversation is taking place.

5. The method of claim 1, wherein said contextually relevant material comprises one or more search results.

6. The method of claim 5, wherein at least some of the search results are associated with locations that are associated with one or more participants in the conversation.

7. The method of claim 5, wherein said one or more search results can be exposed to one or more other participants in the conversation.

8. The method of claim 1, wherein the act of presenting is performed by presenting a user interface for one or more other participants in the conversation.

9. The method of claim 1, wherein the user interface comprises a dropdown window.

10. The method of claim 1, wherein the act of presenting exposes instant messaging functionality.

11. The method of claim 1, wherein the act of presenting exposes non-instant messaging functionality.

12. The method of claim 1, wherein the act of presenting comprises presenting a user interface that includes a shared search portion that can be used by a conversation's participants to jointly enter search terms whose search results are shared amongst the conversation's participants.

13. One or more computer-readable media embodying computer-readable instructions which, when executed, implement a user interface comprising:
an instant messaging conversation window;
one or more highlighted keywords or phrases in said window; and
a user interface portion that displays, for selected keywords or phrases, contextually relevant material or functionality.

14. The user interface of claim 13, wherein at least some of the contextually relevant material or functionality comprises one or more search results.

15. The user interface of claim 13, wherein the user interface portion comprises a shared search area in which search queries can be entered by a conversation's participants

16. The user interface of claim 13, wherein the user interface portion comprises a dropdown menu, and wherein the user interface portion is configured to automatically display search results from other participants in the conversation.

17. A system comprising:
one or more computer-readable media;
computer readable instructions on the computer readable media which, when executed, implement an instant messaging application;
one or more sources of keywords or phrases, wherein the instant messaging application is configured to utilize said one or more sources of keywords or phrases to automatically highlight keywords or phrases in an instant messaging conversation and, responsive to user selection of a keyword or phrase, present a user interface that includes contextually relevant material or functionality, wherein at least a portion of the material includes search results associated with a selected keyword or phrase.

18. The system of claim 17, wherein at least one of the sources of keywords or phrases is a plug-in recognizer.

19. The system of claim 17, wherein at least one of the sources of keywords or phrases comprises individuals on a user's instant messaging buddy list.

20. The system of claim 17, wherein at least one of the sources of keywords or phrases comprises a source that maintains a dynamic list of keywords or phrases.
